(19) United States
(12) Patent Application Publication
(10) Pub. No.: US 2021/0363907 A1
(43) Pub. Date: Nov. 25, 2021

(54) MIXER FOR AN EXHAUST GAS REDUCER

(71) Applicant: FAURECIA SYSTEMES D'ECHAPPEMENT, NANTERRE (FR)

(72) Inventors: Laurent POINSOT, HERICOURT (FR); Alain ENGEL, MEROUX-MOVAL (FR); Philippe ROLLIN, BELFORT (FR)

(21) Appl. No.: 17/323,085

(22) Filed: May 18, 2021

(30) Foreign Application Priority Data
May 19, 2020 (FR) 20 05029

(51) Int. Cl. F01N 3/28; F01N 3/20

(52) U.S. Cl. CPC F01N 3/2892; F01N 3/2066; F01N 2610/1453; F01N 2610/02; F01N 2240/20

(57) ABSTRACT

A mixer mixes an exhaust gas and a reducer, the mixer comprising a box closed and sealed to the exclusion of an inlet and an outlet, and in which the exhaust gas flows from the inlet to the outlet. A reducer sprayer is arranged so that the reducer can be sprayed into an exhaust gas flow. The box has a substantially cylindrical shape with a bottom, a cover, an outer wall, and a deflector. The bottom and the cover are substantially flat, superimposed substantially parallel, and form faces of a cylinder. The outer wall joins perimeters of the bottom and the cover and forms a generator of the cylinder. The cover and the outer wall are made together in a single piece. The deflector is an inner wall that joins the bottom and the cover substantially perpendicularly, and the bottom and the deflector are made together in a single piece.

### CROSS-REFERENCE TO RELATED APPLICATIONS

This application is a U.S. non-provisional application claiming the benefit of French Application No. 20 05029, filed on May 19, 2020, which is incorporated herein by reference in its entirety.

### TECHNICAL FIELD

The disclosure relates to the field of reduction mixers for exhaust gases.

### BACKGROUND

A reduction mixer is typically arranged in an exhaust line of an internal combustion engine. Its function is to mix a reducing fluid, typically an aqueous urea solution: AdBlue, DEF, with the exhaust gas, in preparation for treatment of the mixture by a selective catalytic reductor (SCR) in order to reduce nitrogen oxides.

Different architectures are known for the making such a mixer. In one possible embodiment, a mixer comprises a closed and sealed box except for an inlet and an outlet. The exhaust gas flows through the box from the inlet to the outlet. The mixer further comprises a sprayer capable of spraying a reducer into the box, so that the sprayed reducer mixes with the exhaust gas flowing through the box.

It is also known that, in order to optimize the mixing of the reducer with the exhaust gas, the reducer is sprayed into a gas stream of the longest possible length, so as to increase the common circulation time of the two components and thus improve the mixing. For this purpose, while the space available in an engine and/or exhaust compartment is generally limited, it is still known to use a deflector, arranged in the box, and capable of deflecting the exhaust gas flow, in order to create the longest possible circulation path in the restricted volume allocated to the mixer.

According to one embodiment, the box has a substantially cylindrical shape. The faces of the cylinder form the bottom of the mixer and its cover, respectively. The faces are substantially flat, of the same shape, and are superimposed in a substantially parallel manner. The generator of the cylinder forms an outer wall, joining the perimeter of the bottom and the perimeter of the cover, substantially perpendicular to the bottom and the cover.

It is also known to make the cover in a single piece with the wall. This makes it possible to make it by stamping a single part, ensuring the wall function and simultaneously the cover function.

The deflector, as known, can be an internal wall, arranged in the box, joining the bottom and the cover, substantially perpendicularly, inside the perimeters of the bottom and the cover.

Due to the high temperature induced by the exhaust gas, a mixer and all its components are usually made of metallic material. Due to the temperature, the main way of joining the different components is by welding.

In order to ensure a gas-tight seal, a welded assembly is possible. It is quite simple to weld on the outside of the box. Also, sealing with the outside of the box can be achieved.

However, it can be more difficult to weld components inside the box, especially the deflector assembly with the cover. This can compromise the interior seal. If a leak occurs, the exhaust gas will have a shortcut and will be able to flow more quickly between the inlet and the outlet. This can cause the exhaust gas to contact the reducer and disrupt the function of the mixer.

The alternative to welding to achieve a seal is to make contact/support between the two parts to be sealed, one against the other. This requires precise manufacturing tolerances.

With punching, forming and stamping techniques, it is difficult to obtain precise tolerances. It is also difficult to achieve a seal by simple contact between two parts, due to dimensional dispersions. Furthermore, if a weld is used, it can lead to a deformation of a part which in turn can compromise contact between two parts and thus the sealing.

Also, other paradigms are sought to ensure sealing, primarily at the deflector, both at its lower interface with the bottom, and at its upper interface with the cover.

### SUMMARY

A mixer is provided for mixing an exhaust gas and a reducer, the mixer comprising a closed and sealed box excluding an inlet and an outlet, in which the exhaust gas flows from the inlet to the outlet. A reducer sprayer is arranged to be able to spray the reducer into an exhaust gas flow. The box has a substantially cylindrical shape with a bottom, a cover, an outer wall, and a deflector. The bottom and the cover are substantially flat, are overlapping substantially parallel, and form faces of a cylinder. The outer wall joins perimeters of the bottom and the cover and forms a generator of the cylinder. The cover and the outer wall are made together in a single piece. The deflector is an inner wall joining the bottom and the cover substantially perpendicularly, and the bottom and the deflector are made together of one single piece.

Particular features or embodiments, usable alone or in combination, are:
the inlet is arranged in the outer wall and the outlet is arranged on the bottom,
the sprayer is arranged in the outer wall,
the sprayer is arranged in a common pipe with the inlet, arranged in the outer wall,
the lower junction between the deflector and the bottom has a fillet with a radius of at least 2 mm, preferably at least 10 mm, and even more preferably at least 20 mm,
the deflector has a cross-section, in a plane parallel to the bottom and the cover, which is substantially straight or substantially U-shaped,
a “U”-shaped deflector also comprises a roof connecting the two branches of the “U”, in a sealed manner, by using a sheet substantially parallel to the cover,
at least a part of a roof surface, preferably close to the inlet, or preferably the whole surface, is shaped to come into contact with the cover
the roof is made of the same material as the deflector, together in a single piece, and the upper junction, between the deflector and the roof, has a radius of at least 2 mm, preferably at least 10 mm, and still more preferably at least 20 mm.

In a second aspect of the disclosure, an exhaust line comprises at least one such mixer.

In a third aspect of the disclosure, a motor vehicle comprises such an exhaust line.

### BRIEF DESCRIPTION OF THE DRAWINGS

The disclosure will be better understood from the following description, made only by way of example, and with reference to the appended Figures in which:

FIG. 1 illustrates, in a perspective view, a mixer according to a first embodiment, with the cover cut off,

FIG. 2 illustrates, in a perspective view, the mixer FIG. 1, the entire cover,

FIG. 3 illustrates, in an exploded perspective view, the mixer of FIG. 1,

FIG. 4 illustrates, in a perspective view, a mixer according to another embodiment, with the cover and wall removed,

FIG. 5 illustrates, in a perspective view, the mixer of FIG. 4, with cover and wall in place.

### DETAILED DESCRIPTION

A mixer 1 is designed to mix an exhaust gas and a reducing fluid, in order to prepare a catalytic reaction aimed at reducing nitrogen oxides, NOx, in order to depollute the exhaust gas.

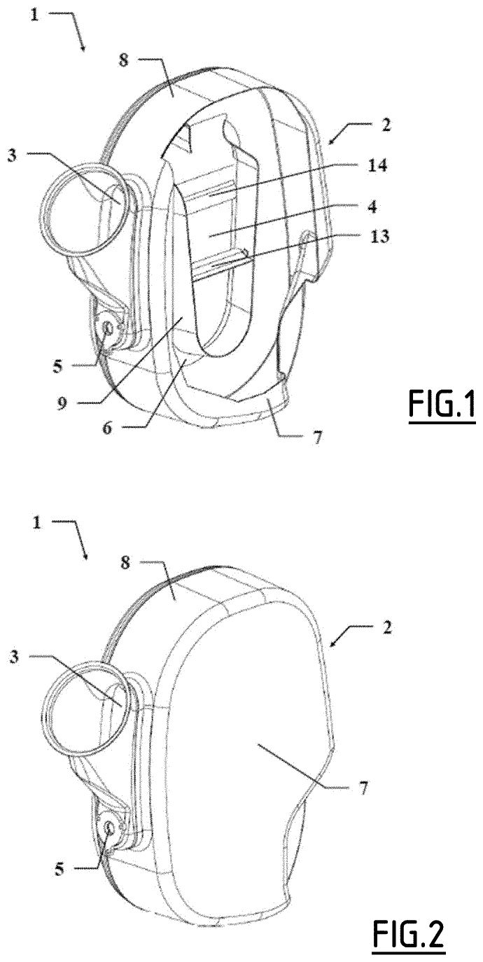

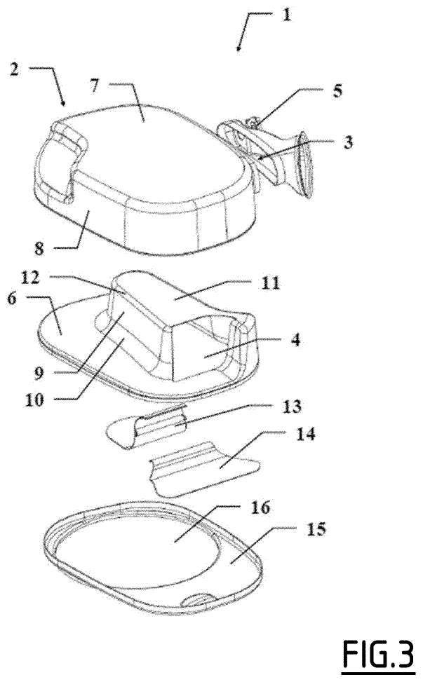

For this purpose, with reference to FIG. 3, illustrating a first embodiment with FIGS. 1 and 2, a mixer 1 comprises a box 2 and a reducer sprayer 5. The box 2 is closed and sealed excluding an inlet 3 and an outlet 4. Between the inlet 3 and the outlet 4, a pipe is arranged, enabling circulation of the exhaust gas from the inlet 3 to the outlet 4. The reducer sprayer 5 is arranged, typically through the outer casing of the box 2, so that the reducer can be sprayed into the exhaust gas flow inside the box 2 in order to achieve mixing.

According to one embodiment, the box 2 has a substantially cylindrical shape. Substantially cylindrical is understood as a generalized cylinder shape obtained by translating a base shape, which may be any shape, substantially parallel to itself. Such a generalized cylinder comprises a first face, substantially flat, reproducing the basic shape, a second face, substantially parallel and identical to the first face. The surface obtained by scanning/translating the base surface, here perpendicular to the base surface, is called the generating surface.

Also, the box 2, comprises a bottom 6, a cover 7, and an outer wall 8, for the outer shell. The bottom 6 and the cover 7 are substantially flat. They are superimposed substantially parallel and form the faces of the cylinder. The wall 8 joins the perimeters of the bottom 6 and the cover 7 and forms the generator of the cylinder.

In order to reduce the number of parts, the cover 7 and the wall 8 can advantageously be made together in one single piece. The common part that joins the cover 7 and the wall 8 can be made by welding between the cover 7 and the wall 8 or by stamping a blank.

Inside the box 2, there is also a deflector 9, the purpose of which is to extend the exhaust gas channel as far as possible in order to increase the contact time with the reducer and thus improve the mixing, both quantitatively and qualitatively.

The deflector 9 is, for example, an inner wall joining the bottom 6 and the cover 7 substantially perpendicularly. The shape of the deflector 9 is such that it forms deflectors opposing a direct path of the exhaust gas from the inlet 3 to the outlet 4. It is substantially parallel to the outer wall 8.

It is appropriate to assemble all these parts together, ensuring a gas-tight seal when necessary. The box 2 can be closed by welding the periphery of the bottom 6 with the lower edge of the facing wall 8.

The difficulty comes with the deflector 9. It can advantageously be welded on one of the faces among the bottom 8 and the cover 7. But welding on the other side is more delicate in that the area to be welded is necessarily inside the box 2 and therefore difficult to access. An alternative to the difficult welding of the deflector 9 on the other of the faces among the bottom 8 and the cover 7 is a contact, preferably with a support, to ensure the sealing. However, welding the deflector 9 to the first side usually results in deformation of the deflector 9. The resulting dimensional dispersion hinders the contact with support on the other side and thus the sealing is not guaranteed.

Also, the assembly of the deflector 9 with the bottom 6 is not made by welding. According to a characteristic of the disclosure, the bottom 6 and the deflector 9 are made together in one single piece. This allows for manufacturing methods that result in a much smaller dimensional dispersion. It is then possible to ensure the sealing between the deflector 9 and the cover 7 by simple support contact. Such a contact between the deflector 9 and the cover 7 may result in a slight leakage. Such leakage is much less than the main flow rate, typically less than 1%. It is also possible to observe the reducer passing from the reducer sprayer 5 by capillarity. Even if it is more delicate, welding the cover 7 with the upper edge of the deflector 9 is possible here, for example by transparency, through the cover 7.

The common part that joins the deflector 9 and the bottom 6 can advantageously be made by stamping.

According to another feature, the inlet 3 is arranged at the edge of the box 2, i.e., in the wall 8. This is more particularly visible in FIGS. 1, 2, and 5. The sprayer 5 is preferably arranged to spray in the exhaust gas flow in a region where the exhaust gas flow has as long a straight portion as possible, in order to improve the quality of the mixture. The use of the longest possible straight portion also has the advantage that spraying is not carried out against an opposing wall surface. This promotes evaporation of the reducing fluid into the exhaust gas volume before it meets a wall. This is particularly significant for a urea-based reducing fluid that could create parasitic deposit reactions that could solidify on the wall. Such a deposit is thus minimized.

Also, the sprayer 5 is advantageously arranged in the wall 8. Advantageously, the sprayer 5 is arranged directly on the inlet pipe.

According to another feature, the outlet 4 is arranged on one of the sides, for example the bottom 6.

According to another feature, the lower junction 10, between the deflector 9 and the bottom 6, has a fillet. The radius of this fillet is at least equal to 2 mm, preferably at least equal to 10 mm and even more preferably at least equal to 20 mm. This feature facilitates the production of the common part joining the bottom and the wall 8 in that a fillet facilitates stamping, in that it reduces the force to be applied and reduces the risks of breakage by strain hardening.

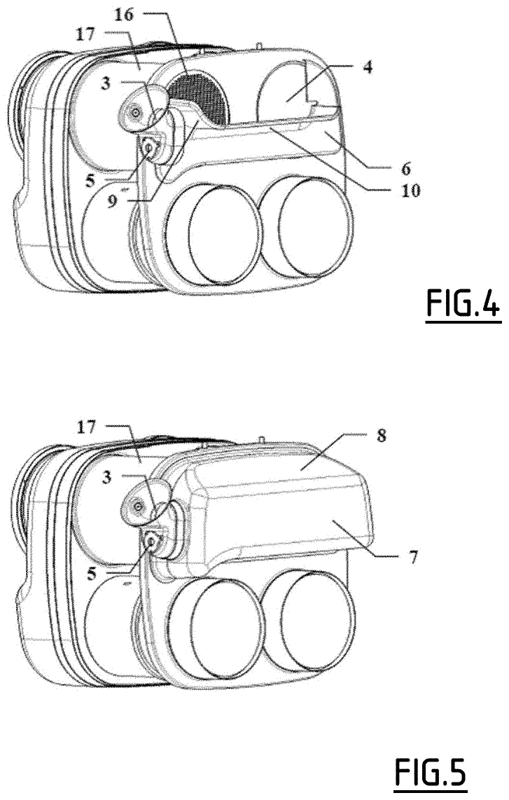

According to another feature, the deflector 9 has a substantially rectilinear cross-section, in a plane parallel to the bottom 6 and the cover 7. This is illustrated by the embodiment shown in FIGS. 4 and 5.

According to another feature, the deflector 9 has a section, according to a plane parallel to the bottom 6 and to the cover 7, substantially in the shape of a “U”. This is illustrated by the embodiment shown in FIGS. 1-3. Such a U-shape makes it possible to form a spiral to lengthen the path of the exhaust gas, in order to improve the mixing of the reducer and the exhaust gas.

According to another feature, more particularly visible in FIG. 3, in the case of a “U” shaped deflector 9, it is possible to add a roof 11 connecting, in a sealed manner, the two branches of the “U”. This roof 11 is a metal sheet substantially parallel to the cover 7. The roof 11 forms a surface in contact with the cover 7 and thus provides a better seal than a line in contact. The contact surface between the roof 11 and the cover 7 is advantageously the entire surface of the roof 11. If the contact surface is partial, the area near the inlet 3 is preferred. This feature makes it possible to block a leak that would cause the gas to bypass the deflector 9 as soon as possible, i.e., as close as possible to the inlet 3. The contact is realized with support by having a tight adjustment carried out during the assembly. Moreover, if the seal is not perfect and leaves a leak, this leak occurs between one branch of the U and the other branch and not directly with the outlet 4. As with the line contact between the upper edge of the deflector 9 and the cover 7, a slight leakage is possible. Because of the contact surface, relative to a line, this leakage is still reduced. It is also possible to observe a passage of reducer from the sprayer 5 by capillarity. As before, even if it is more delicate, a welding of the cover 7 with the roof 11 is possible here, along a line or on the contact surface, for example by transparency, through the cover 7.

According to another feature, the roof 11 is made of the same material as the deflector 9, together in one single piece. This feature advantageously allows a common part joining the roof 11 and the deflector 9, and thus the bottom 6, to be made, for example, by stamping.

As seen previously, a stamping embodiment benefits from a soft shape, with a certain radius, rather than a sharp edge. Also, according to another characteristic, the upper junction 12, between the deflector 9 and the roof 11, advantageously has a rounding. The radius of this rounding is at least equal to 2 mm, preferably at least equal to 10 mm, and even more preferably at least equal to 20 mm.

As seen in FIG. 3, two vanes 13, 14 can be arranged in the outlet 4 in order to guide the mixture of exhaust gases and reducer towards the inlet 16 of the following element 17 (FIGS. 4-5), typically an SCR catalyst. The part 15 provides an interface to the subsequent element 17.

The lower, rounded junction 10 between the deflector 9 and the bottom 6 can also be used to guide the exhaust and reducer mixture to the inlet 16 of the next element 17.

The disclosure further relates to an exhaust line comprising at least one such mixer 1.

The disclosure further relates to a motor vehicle comprising such an exhaust line.

The disclosure has been illustrated and described in detail in the drawings and the preceding description. The latter should be considered as illustrative and given as an example and not as limiting the disclosure to this description alone. Many alternative embodiments are possible.

### LIST OF REFERENCE SIGNS

1: mixer,
2: box,
3: inlet,
4: outlet,
5: sprayer,
6: bottom,
7: cover,
8: wall,
9: deflector,
10: bottom joint,
11: roof,
12: upper junction,
13, 14: paddles,
15: interface,
16: entrance of the next element,
17: next element

1. A mixer for mixing an exhaust gas and a reducer, comprising:
a box closed and sealed excluding an inlet and an outlet, in which exhaust gas flows from the inlet to the outlet;
a reducer sprayer arranged in such a way that the reducer can be sprayed into an exhaust gas flow;
the box having a cylindrical shape with a bottom, a cover, an outer wall, and a deflector, and wherein the bottom and the cover are flat, superimposed parallel, and form faces of a cylinder, and wherein the outer wall joins perimeters of the bottom and the cover and forms a generator of the cylinder;
the cover and the outer wall being made together in a single piece; and
the deflector being an inner wall joining the bottom and the cover perpendicularly, wherein the bottom and the deflector are made together in a single piece.

2. The mixer according to claim 1, wherein the inlet is formed in the outer wall and the outlet is formed in the bottom.

3. The mixer according to claim 1, wherein the reducer sprayer is arranged in the outer wall.

4. The mixer according to claim 1, wherein the reducer sprayer is arranged in a common pipe with the inlet, which is arranged in the outer wall.

5. The mixer according to claim 1, wherein a lower junction, between the deflector and the bottom, has a fillet of a radius that is at least 2 mm.

6. The mixer according to claim 1, wherein a lower junction, between the deflector and the bottom, has a fillet of a radius that is at least 10 mm.

7. The mixer according to claim 1, wherein a lower junction, between the deflector and the bottom, has a fillet of a radius that is at least 20 mm.

8. The mixer according to claim 1, wherein the deflector has a section, along a plane parallel to the bottom and to the cover, that is rectilinear.

9. The mixer according to claim 1, wherein the deflector has a section, along a plane parallel to the bottom and to the cover, that is “U” shaped.

10. The mixer according to claim 9, wherein the deflector further comprises a roof connecting two branches of the “U”, in a sealed manner, by a plate parallel to the cover.

11. The mixer according to claim 10, wherein at least a part of a surface of the roof is shaped to come to rest against the cover.

12. The mixer according to claim 11, wherein the part of the surface is close to the inlet.

13. The mixer according to claim 11, wherein the part of the surface extends on an entirety of the surface.

14. The mixer according to claim 10, wherein the roof is made in a single piece with the deflector, and wherein an upper junction, between the deflector and the roof, has a rounding of a radius that is at least 2 mm.

15. The mixer according to claim 10, wherein the roof is made in a single piece with the deflector, and wherein an upper junction, between the deflector and the roof, has a rounding of a radius that is at least 10 mm.

16. The mixer according to claim 10, wherein the roof is made in a single piece with the deflector, and wherein an upper junction, between the deflector and the roof, has a rounding of a radius that is at least 20 mm.

17. The mixer according to claim 11, wherein the roof is made in a single piece with the deflector, and wherein an upper junction, between the deflector and the roof, has a rounding of a radius that is at least 2 mm.

18. The mixer according to claim 11, wherein the roof is made in a single piece with the deflector, and wherein an upper junction, between the deflector and the roof, has a rounding of a radius that is at least 10 mm.

19. The mixer according to claim 11, wherein the roof is made in a single piece with the deflector, and wherein an upper junction, between the deflector and the roof, has a rounding of a radius that is at least 20 mm.

20. An exhaust line comprising:
at least one mixer for mixing an exhaust gas and a reducer, the at least one mixer comprising a box closed and sealed excluding an inlet and an outlet, in which the exhaust gas flows from the inlet to the outlet;
a reducer sprayer arranged in such a way that the reducer can be sprayed into an exhaust gas flow;
the box having a cylindrical shape with a bottom, a cover, an outer wall, and a deflector, and wherein the bottom and the cover are flat, superimposed parallel, and form faces of a cylinder, and wherein the outer wall joins perimeters of the bottom and the cover and form a generator of the cylinder;
the cover and the outer wall being made together in a single piece; and
the deflector being an inner wall joining the bottom and the cover perpendicularly, wherein the bottom and the deflector are made together in a single piece.

21. A motor vehicle comprising:
an exhaust line comprising at least one mixer for mixing an exhaust gas and a reducer;
the at least one mixer comprising a box closed and sealed excluding an inlet and an outlet, in which the exhaust gas flows from the inlet to the outlet;
a reducer sprayer arranged in such a way that the reducer can be sprayed into an exhaust gas flow;
the box having a cylindrical shape with a bottom, a cover, an outer wall, and a deflector, and wherein the bottom and the cover are flat, superimposed parallel, and form faces of a cylinder, and wherein the outer wall joins perimeters of the bottom and the cover and form a generator of the cylinder;
the cover and the outer wall being made together in a single piece; and
the deflector being an inner wall joining the bottom and the cover perpendicularly, wherein the bottom and the deflector are made together in a single piece.
